(19) United States
(12) Patent Application Publication
(10) Pub. No.: US 2022/0089915 A1
(43) Pub. Date: Mar. 24, 2022

(54) UV DEBONDABLE PRESSURE SENSITIVE ADHESIVE COMPOSITION AND PRESSURE SENSITIVE ADHESIVE TAPE

(71) Applicant: 3M INNOVATIVE PROPERTIES COMPANY, St. Paul, MN (US)

(72) Inventors: Chao Yang, Shanghai (CN); Wei Cui, Shanghai (CN); Guannan Yin, Shanghai (CN)

(21) Appl. No.: 17/310,145

(22) PCT Filed: Feb. 14, 2020
(86) PCT No.: PCT/IB2020/051260

§ 371 Date: Jul. 21, 2021

(30) Foreign Application Priority Data
Feb. 21, 2019 (CN) 201910135583.1

(51) Int. Cl. C09J 7/38; C08F 220/32; C08F 220/06; C08F 220/14; C08F 220/18; C08F 222/10; C08F 2/48

(52) U.S. Cl. CPC C09J 7/385; C09J 2433/00; C08F 220/06; C08F 220/14; C08F 220/1804; C08F 222/1065; C08F 2/48; C09J 2203/326; C09J 2301/416; C09J 2301/502; C09J 2301/122; C09J 2301/302; C09J 2423/001; C09J 2467/001; C09J 2475/001; C09J 2477/001; C08F 220/325

(57) ABSTRACT

The present invention provides a UV debondable pressure sensitive adhesive composition and an adhesive tape comprising the same. The UV debondable pressure sensitive adhesive composition comprises a polyacrylate pressure sensitive adhesive, a UV-light polymerizable polyurethane oligomer, a cationic photoinitiator and a free radical photoinitiator, wherein polymerization monomers of the polyacrylate pressure sensitive adhesive comprise an acrylic monomer having an epoxy functional group. The UV debondable pressure sensitive adhesive composition has a bonding force dropping significantly upon UV irradiation, and leaves no residual adhesive.

### TECHNICAL FIELD

The present invention relates to the field of pressure sensitive adhesives, and in particular, to a UV debondable pressure sensitive adhesive composition and a pressure sensitive adhesive tape comprising the same.

### BACKGROUND

UV-light debondable pressure sensitive adhesives are also known as UV debondable adhesives, which refer to a class of pressure sensitive adhesives having a decreased bonding force through UV-light excitation. The UV debondable adhesives feature convenient application, high initial bonding force, and easy removal after UV debonding. The UV debondable adhesives can be used in semiconductor processing for temporary fixing during wafer dicing and serving as protecting adhesive tapes. The UV debondable adhesives can also be used for temporary protection of exterior parts during manufacturing and processing. The UV debondable adhesives can further be applied to adhesive tapes for the transport of manufactured flexible circuit boards. The good bonding force of the adhesive tapes can ensure that the flexible circuit boards will not fall off in the process of nickel or gold melting. Moreover, the adhesive tapes are easy to remove after debonding, preventing the deformation of the flexible circuit boards caused by an excessive bonding force during removal of the protective adhesive tapes. The UV debondable adhesives can also be used in the medical field. As an ordinary medical adhesive tape is attached to the skin for a long period of time, the bonding force will gradually increase. For some areas where the skin is vulnerable, removal of the ordinary medical adhesive tape may cause skin tears. A medical UV debondable adhesive can reduce a bonding force by irradiation of a low dose of UV-light, and reduce the pain of patients when the adhesive tape is removed. Compared with traditional protective films, UV debondable adhesives have a higher bonding force in protection projects and are easier to remove after debonding.

Existing UV debondable adhesives are typically comprised of a pressure sensitive adhesive, a UV-light polymerizable oligomer (also referred to as a UV oligomer, or a debondable resin) and a free radical photoinitiator. The pressure sensitive adhesive provides an initial bonding force. When irradiated by UV-light, the UV oligomer undergoes a crosslinking reaction under the action of the free radical photoinitiator, to increase the overall modulus of the debondable adhesive. In this way, the adhesive layer hardens and loses the bonding force.

However, when the existing debondable adhesive compositions are subjected to debonding, the interaction between the pressure sensitive adhesive and the UV oligomer usually only involves molecular chain interaction. The insufficient interaction between the pressure sensitive adhesive and the UV oligomer often results in the fact that the pressure sensitive adhesive is not affected by the UV oligomer, which in turn results in the local formation of residual adhesive, or an insufficient decrease or even an abnormal increase in a bonding force.

### SUMMARY

In one aspect, the present invention provides a UV debondable pressure sensitive adhesive composition, the pressure sensitive adhesive composition comprising:

20 to 80 parts by weight of a polyacrylate pressure sensitive adhesive, polymerization monomers of the polyacrylate pressure sensitive adhesive comprising an acrylic monomer having an epoxy functional group;

20 to 80 parts by weight of a UV-light polymerizable polyurethane oligomer, the UV-light polymerizable polyurethane oligomer having a glass transition temperature upon UV polymerization of 60° C. or more;

0.1 to 5 parts by weight of a cationic photoinitiator; and

0.1 to 5 parts by weight of a free radical photoinitiator.

In one embodiment, the UV-light polymerizable polyurethane oligomer has a glass transition temperature upon UV polymerization of 90° C. or more.

In one embodiment, the acrylic monomer having an epoxy functional group accounts for 0.1 wt % to 10 wt % of the polymerization monomers of the polyacrylate pressure sensitive adhesive.

In one embodiment, the acrylic monomer having an epoxy functional group comprises acrylic glycidyl ether or methacrylic glycidyl ether.

In one embodiment, the polymerization monomers of the polyacrylate pressure sensitive adhesive further comprise a monomer having no epoxy functional group and selected from the group consisting of an acrylate and acrylic acid.

In one embodiment, the UV-light polymerizable polyurethane oligomer has a viscosity at 25° C. of 1000 mPa·s to 100,000 mPa·s.

In one embodiment, the UV debondable pressure sensitive adhesive composition further comprises a solvent.

In another aspect, the present invention provides a pressure sensitive adhesive tape, comprising:

a base film; and

a layer of the aforementioned UV debondable pressure sensitive adhesive composition on the base film.

In one embodiment, the base film is selected from the group consisting of a polyolefin film, a polyethylene terephthalate film, a polyetheretherketone film, a polyamide film and a polyurethane film.

### DETAILED DESCRIPTION

The present invention provides a UV debondable pressure sensitive adhesive composition, the UV debondable pressure sensitive adhesive composition comprising:

20 to 80 parts by weight of a polyacrylate pressure sensitive adhesive, polymerization monomers of the polyacrylate pressure sensitive adhesive comprising an acrylic monomer having an epoxy functional group;

20 to 80 parts by weight of a UV-light polymerizable polyurethane oligomer, the UV-light polymerizable polyurethane oligomer having a glass transition temperature upon UV polymerization of 60° C. or more;

0.1 to 5 parts by weight of a cationic photoinitiator; and

0.1 to 5 parts by weight of a free radical photoinitiator.

Compared with conventional UV debondable adhesives, the polymerization monomers of the polyacrylate pressure sensitive adhesive in the debondable adhesive composition of the present invention comprise an acrylic monomer having an epoxy functional group, and a polyurethane oligomer and a cationic photoinitiator are selected, where the polyurethane oligomer has a glass transition temperature upon UV polymerization of 60° C. or more, and preferably 90° C. or more. In the synthesis of the polyacrylate pressure sensitive adhesive, the introduction of the monomer having an epoxy functional group can allow the resultant polyacrylate pressure sensitive adhesive to also undergo rapid UV crosslinking curing under the action of the cationic photoinitiator. The curing of the polyacrylate pressure sensitive adhesive occurs simultaneously with the foregoing curing caused by the polyurethane oligomer, forming a unique UV-light dual-curing mechanism. In addition, the above polyurethane oligomer selected as the UV oligomer can react chemically with the epoxy group in the polyacrylate pressure sensitive adhesive while undergoing the crosslinking reaction. In this way, when debonding is carried out with UV, the debondable adhesive composition of the present invention simultaneously undergoes a crosslinking reaction of the polyacrylate pressure sensitive adhesive, a crosslinking reaction of the oligomer, and an interaction between the polyacrylate pressure sensitive adhesive and the oligomer. These three processes occur synergistically, bringing many advantages. Firstly, when a traditional UV debondable adhesive undergoes a debonding reaction, it is difficult for a pressure sensitive adhesive to interact effectively with a debondable resin, leading to the problems of residual adhesives and increases in local bonding forces. In the present invention, these problems can be effectively avoided by providing epoxy groups in the polyacrylate pressure sensitive adhesive and selecting a specific polyurethane oligomer. Furthermore, compared with traditional UV debondable adhesives, the polyacrylate pressure sensitive adhesive resin having epoxy groups itself can also be cured through the crosslinking mechanism of the cationic photoinitiator, thus increasing the modulus of the pressure sensitive adhesive, so as to further reduce a bonding force.

The polyacrylate pressure sensitive adhesive in the pressure sensitive adhesive composition of the present invention is polymerized from acrylic polymerization monomers. Any acrylic polymerization monomer conventional in the art that can be polymerized to prepare polyacrylate pressure sensitive adhesives can be used, as long as it does not conflict with the principles of the present invention. The present invention is characterized in that the polymerization monomers of the polyacrylate pressure sensitive adhesive must comprise an acrylic monomer having an epoxy functional group. As stated above, the acrylic monomer having an epoxy functional group provides a dual-curing mechanism and beneficial interaction with the polyurethane oligomer.

The acrylic monomer having an epoxy functional group may account for 0.1 wt % to 10 wt % of the polymerization monomers of the polyacrylate pressure sensitive adhesive. When the acrylic monomer having an epoxy functional group is in this range, the acrylic monomer provides good debonding effects without affecting the bonding properties of the pressure sensitive adhesive composition before debonding, and is cost effective.

Preferred examples of the acrylic monomer having an epoxy functional group include acrylic glycidyl ether or methacrylic glycidyl ether.

The polymerization monomers may further comprise a monomer having no epoxy functional group and selected from the group consisting of an acrylate and acrylic acid. The acrylate and the acrylic acid also include methacrylate and methacrylic acid, unless otherwise specified herein. The acrylate may be, for example, an alkyl acrylate, such as methyl acrylate, methyl methacrylate, 2-ethylethyl acrylate and butyl acrylate, and a substituted alkyl acrylate, such as hydroxyethyl acrylate.

The UV-light polymerizable polyurethane oligomer in the pressure sensitive adhesive composition of the present invention is an oligomer having a carbon-carbon double bond. The glass transition temperature upon UV polymerization thereof should be 60° C. or more. Polyurethane oligomers with this property have excellent ability to reduce a bonding force through UV-light crosslinking. If a polyurethane oligomer with an excessively low glass transition temperature upon UV polymerization is used, the bonding force of the resultant product decreases insufficiently and the product is not easy to debond.

The polyurethane oligomer has a viscosity at 25° C. of 1000 mPa·s to 100,000 mPa·s. Polyurethane oligomers with this viscosity interact better with epoxy groups on the backbone of the polyacrylate pressure sensitive adhesive, thereby better avoiding the occurrence of residual adhesive.

The polyurethane oligomer may be a commercially available product, for example, CN8000NS, CN9006NS and CN983NS from Sartomer Corporation, and 6145-100 from Eternal Chemical.

The cationic photoinitiator and the free radical photoinitiator contained in the pressure sensitive adhesive composition of the present invention may be any suitable photoinitiators, as long as they do not conflict with the principles of the present invention.

The weight ratio of the polyacrylate pressure sensitive adhesive, the UV-light polymerizable polyurethane oligomer, the cationic photoinitiator and the free radical photoinitiator in the pressure sensitive adhesive composition according to the present invention is 20-80:20-80:0.1-5:0.1-5. Within this range, the pressure sensitive adhesive composition of the present invention can have both good bonding performance and good debonding performance at the same time.

The pressure sensitive adhesive composition of the present invention may further comprise a proper solvent. The solvent is used to mix the pressure sensitive adhesive composition well. After the pressure sensitive adhesive composition is prepared into an article such as an adhesive tape, the solvent can be evaporated off.

The pressure sensitive adhesive composition of the present invention has a high initial bonding force and leaves no residual adhesive after debonding. After UV debonding, the bonding force can drop by 90% or more.

The present invention further provides a pressure sensitive adhesive tape, comprising:

a base film; and

a layer of the aforementioned UV debondable pressure sensitive adhesive composition on the base film.

The base film may be any suitable base film, especially a base film for protection. Examples of suitable base films may include a polyolefin film, a polyethylene terephthalate film, a polyetheretherketone film, a polyamide film, a polyurethane film, etc. The polyolefin film may be, for example, a polypropylene film or a polyethylene film.

The pressure sensitive adhesive tape of the present invention can be prepared by coating the UV debondable pressure sensitive adhesive composition of the present invention onto the base film. The pressure sensitive adhesive tape has a UV debonding function. The tape has a high initial bonding force and leaves no residual adhesive after debonding. After UV debonding, the bonding force can drop by 90% or more. The pressure sensitive adhesive tape of the present invention can be used in the fields of semiconductor processing, exterior part manufacturing and processing, flexible circuit board processing, and medical treatment, etc.

The present invention is explained below with examples. It should be noted that the examples are merely exemplary and are not intended to limit the scope of the present invention.

### Example 1

An acrylic pressure sensitive adhesive having epoxy functional groups was synthesized first. Butyl acrylate, methyl acrylate, acrylic acid and methacrylic glycidyl ether (at a weight ratio of 60:30:6:4) were added into a reaction kettle, toluene was used as a solvent, benzoyl peroxide (BPO) was added as an initiator, and the mixture was reacted at 70° C. for 24 h followed by discharge. A polyurethane oligomer (CN8000NS from US Sartomer Corporation) was added into the resultant pressure sensitive adhesive, followed by addition of a cationic photoinitiator and a free radical photoinitiator, in a particular proportion as shown in the following table. In the following table, the percentage by weight is based on the total amount of components other than the solvent.

The cationic photoinitiator was 1176 produced by Taiwan Double Bond Chemical. The free radical photoinitiator was 184 produced by BASF. CN8000NS had a viscosity at 25° C. of 14000 mPa·s, and a glass transition temperature upon UV-light crosslinking of 65° C.

The adhesive was coated on a 50 μm polyethylene terephthalate (PET) film and oven-dried to give a UV debondable protective adhesive tape. The adhesive tape was attached onto the surface of anodic aluminum oxide. The initial bonding force was 0.8 N/mm on anodic aluminum oxide. Upon UV irradiation at a dose of 1000 mJ/cm², the bonding force dropped to 0.005 N/mm. After removal of the adhesive tape, no residual adhesive existed on the surface of anodic aluminum oxide.

| Composition | Percentage by weight |
|---|---|
| Pressure sensitive adhesive | 60 |
| CN8000NS | 36 |
| Cationic photoinitiator | 2 |
| Free radical photoinitiator | 2 |

### Example 2

An acrylic pressure sensitive adhesive having epoxy functional groups was synthesized first. 2-ethylethyl acrylate, methyl acrylate, acrylic acid and acrylic glycidyl ether (at a weight ratio of 55:35:7:3) were added into a reaction kettle, toluene was used as a solvent, BPO was added as an initiator, and the mixture was reacted at 70° C. for 24 h followed by discharge. A polyurethane oligomer (CN8000NS from US Sartomer) was added into the resultant pressure sensitive adhesive, followed by addition of a cationic photoinitiator and a free radical photoinitiator, in a particular proportion as shown in the following table.

The cationic photoinitiator was 1176 produced by Taiwan Double Bond Chemical. The free radical photoinitiator was TPO-L produced by Taiwan Double Bond Chemical. CN8000NS had a viscosity at 25° C. of 14000 mPa·s, and a glass transition temperature upon UV-light crosslinking of 70° C.

The adhesive was coated on a PET film, and oven-dried to give a UV debondable protective adhesive tape. The adhesive tape was attached onto an anodic aluminum oxide plate. The initial bonding force was 0.86 N/mm. Upon UV irradiation at a dose of 750 mJ/cm², the bonding force dropped to 0.003 N/mm. After removal of the adhesive tape, no residual adhesive existed on the surface of the anodic aluminum oxide plate.

| Composition | Percentage by weight |
|---|---|
| Pressure sensitive adhesive | 50 |
| CN8000NS | 45 |
| Cationic photoinitiator | 1 |
| Free radical photoinitiator | 4 |

### Example 3

An acrylic pressure sensitive adhesive having epoxy functional groups was synthesized first. 2-ethylethyl acrylate, methyl methacrylate, hydroxyethyl acrylate and methacrylic glycidyl ether (at a weight ratio of 60:26:10:4) were added into a reaction kettle, toluene was used as a solvent, BPO was added as an initiator, and the mixture was reacted at 70° C. for 24 h followed by discharge. A polyurethane oligomer (6145-100 from Eternal Chemical) was added into the resultant pressure sensitive adhesive, followed by addition of a cationic photoinitiator and a free radical photoinitiator, in a particular proportion as shown in the following table.

The cationic photoinitiator was Irgacure 250. The free radical photoinitiator was TPO. 6145-100 had a viscosity at 25° C. of 70000 mPa·s, and a glass transition temperature upon UV-light crosslinking of 104° C.

The adhesive was coated on a biaxially oriented polypropylene (BOPP) film and oven-dried to give a UV debondable protective adhesive tape. The adhesive tape was attached onto the surface of a standard steel plate. The initial bonding force was 0.92 N/mm. Upon UV irradiation at a dose of 1000 mJ/cm², the bonding force dropped to 0.002 N/mm. After removal of the adhesive tape, no residual adhesive existed on the surface of the steel plate.

| Composition | Percentage by weight |
|---|---|
| Pressure sensitive adhesive | 44.5 |
| 6145-100 | 50 |
| Cationic photoinitiator | 1.5 |
| Free radical photoinitiator | 4 |

### Example 4

An acrylic pressure sensitive adhesive having epoxy functional groups was synthesized first. 2-ethylethyl acrylate, methyl acrylate, acrylic acid and acrylic glycidyl ether (at a weight ratio of 55:35:7:3) were added into a reaction kettle, toluene was used as a solvent, BPO was added as an initiator, and the mixture was reacted at 70° C. for 24 h followed by discharge. A polyurethane oligomer (CN9006NS from US Sartomer) was added into the resultant pressure sensitive adhesive, followed by addition of a cationic photoinitiator and a free radical photoinitiator, in a particular proportion as shown in the following table.

The cationic photoinitiator was CPI-100P. The free radical photoinitiator was TPO. CN9006NS had a viscosity of 2000 mPa·s, and a glass transition temperature upon UV-light crosslinking of 145° C.

The adhesive was coated on a PET film, and oven-dried to give a UV debondable protective adhesive tape. The adhesive tape was attached onto standard anodic aluminum oxide. The initial bonding force was 0.82 N/mm. Upon UV irradiation at a dose of 500 mJ/cm², the bonding force dropped to 0.005 N/mm. After removal of the adhesive tape, no residual adhesive existed on the surface of the anodic aluminum oxide.

| Composition | Percentage by weight |
|---|---|
| Pressure sensitive adhesive | 62 |
| CN9006NS | 35 |
| Cationic photoinitiator | 1 |
| Free radical photoinitiator | 2 |

### Example 5

An acrylic pressure sensitive adhesive having epoxy functional groups was synthesized first. 2-ethylethyl acrylate, methyl methacrylate, acrylic acid and methacrylic glycidyl ether (at a weight ratio of 60:26:10:4) were added into a reaction kettle, toluene was used as a solvent, BPO was added as an initiator, and the mixture was reacted at 70° C. for 24 h followed by discharge. A polyurethane oligomer (CN983NS from US Sartomer) was added into the resultant pressure sensitive adhesive, followed by addition of a cationic photoinitiator and a free radical photoinitiator, in a particular proportion as shown in the following table.

The cationic photoinitiator was CPI-100P. The free radical photoinitiator was Darocur 1173. CN983NS had a viscosity of 5500 mPa·s, and a glass transition temperature upon UV-light crosslinking of 92° C.

The adhesive was coated on a BOPP film, and oven-dried to give a UV debondable protective adhesive tape. The adhesive tape was attached onto the surface of a standard steel plate. The initial bonding force was 0.95 N/mm. Upon UV irradiation at a dose of 800 mJ/cm², the bonding force dropped to 0.002 N/mm. After removal of the adhesive tape, no residual adhesive existed on the surface of the steel plate.

| Composition | Percentage by weight |
|---|---|
| Pressure sensitive adhesive | 65 |
| CN983NS | 30 |
| Cationic photoinitiator | 2 |
| Free radical photoinitiator | 3 |

It can be seen from the above examples that, the bonding force of the composition of the present invention dropped greatly upon UV irradiation, and no residual adhesive appeared.

### Comparative Example 1

Comparative example 1 was the same as Example 1, except that methacrylic glycidyl ether was replaced by a monomer containing no epoxy group. Results showed that the bonding force dropped to 0.13 N/mm, and residual adhesive existed on the surface of the steel plate after removal subsequent to UV irradiation.

### Comparative Example 2

Comparative example 2 was the same as Example 1, except that the polyurethane oligomer was replaced by CN8009NS, the viscosity was 517 mPa·s, and Tg upon UV irradiation was 10° C. Results showed that, upon irradiation with 1000 mJ/cm² UV, the bonding force was 1.01 N/mm, and UV debonding could not be achieved.

### Comparative Example 3

Comparative example 3 was the same as Example 1, except that no cationic photoinitiator was added. Results showed that the bonding force dropped to 0.2 N/mm, and residual adhesive existed on the surface of the steel plate.

1. A UV debondable pressure sensitive adhesive composition, the UV debondable pressure sensitive adhesive comprising:
20 to 80 parts by weight of a polyacrylate pressure sensitive adhesive, polymerization monomers of the polyacrylate pressure sensitive adhesive comprising an acrylic monomer having an epoxy functional group;
20 to 80 parts by weight of a UV-light polymerizable polyurethane oligomer, the UV-light polymerizable polyurethane oligomer having a glass transition temperature upon UV polymerization of 60° C. or more;
0.1 to 5 parts by weight of a cationic photoinitiator; and
0.1 to 5 parts by weight of a free radical photoinitiator.

2. The UV debondable pressure sensitive adhesive composition according to claim 1, wherein the UV-light polymerizable polyurethane oligomer has a glass transition temperature upon UV polymerization of 90° C. or more.

3. The UV debondable pressure sensitive adhesive composition according to claim 1, wherein the acrylic monomer having an epoxy functional group accounts for 0.1 wt % to 10 wt % of the polymerization monomers of the polyacrylate pressure sensitive adhesive.

4. The UV debondable pressure sensitive adhesive composition according to claim 1, wherein the acrylic monomer having an epoxy functional group comprises acrylic glycidyl ether or methacrylic glycidyl ether.

5. The UV debondable pressure sensitive adhesive composition according to claim 1, wherein the polymerization monomers of the polyacrylate pressure sensitive adhesive further comprise a monomer having no epoxy functional group and selected from the group consisting of an acrylate and acrylic acid.

6. The UV debondable pressure sensitive adhesive composition according to claim 1, wherein the UV-light polymerizable polyurethane oligomer has a viscosity at 25° C. of 1000 mPa·s to 100,000 mPa·s.

7. The UV debondable pressure sensitive adhesive composition according to claim 1, wherein the UV debondable pressure sensitive adhesive composition further comprises a solvent.

8. A pressure sensitive adhesive tape, comprising:
a base film; and
a layer of the UV debondable pressure sensitive adhesive composition of claim 1 on the base film.

9. The pressure sensitive adhesive tape according to claim 8, wherein
the base film is selected from the group consisting of a polyolefin film, a polyethylene terephthalate film, a polyetheretherketone film, a polyamide film and a polyurethane film.
